(19) United States
(12) Patent Application Publication
(10) Pub. No.: US 2008/0192827 A1
(43) Pub. Date: Aug. 14, 2008

(54) Video Processing With Region-Based Multiple-Pass Motion Estimation And Update Of Temporal Motion Vector Candidates

(75) Inventors: Aleksander Beric, Eindhoven (NL); Ramanathan Sethuraman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,997

(22) PCT Filed: Apr. 4, 2006
(86) PCT No.: PCT/IB06/51016

§ 371 Date: Oct. 9, 2007

(30) Foreign Application Priority Data
Apr. 12, 2005 (EP) 05102852.0

(51) Int. Cl. H04N 7/12

(52) U.S. Cl. 375/240.16; 375/E07.104

(57) ABSTRACT

The present invention relates to the field of motion estimation in video processing. Specifically the invention relates to a video-processing method and device for ascertaining motion vectors for a plurality of first pixel blocks forming a currently processed image region of a currently processed image of an image sequence. The invention addresses the problem of the impact of region-based motion estimation on the quality of the video output in video applications like picture-rate up conversion. The video-processing device of the invention comprises a processing unit, which is adapted to ascertain motion vectors for a plurality of first pixel blocks (C), which form a currently processed image region (200.1 to 200.14) of a currently processed image (200) of an image sequence, proceeding from image region to image region and processing a respective image region at least twice before proceeding to a next image region. Ascertaining a motion vector for a currently processed first pixel block (C) of the image region is performed by evaluating a respective set of candidate motion vectors containing at least one temporal candidate vector, which is a motion vector that was ascertained for a second pixel block (T) of a preceding image of the image sequence. The video-processing device of the invention is adapted to update, before processing a respective image region (200.2) of the currently processed image a second time, a temporal candidate vector, which was ascertained for a third pixel block located outside the currently processed image region (200.2) in the preceding image, by ascertaining a motion vector for the third pixel block (216) in the currently processed image and replacing the temporal candidate vector with it. By updating temporal motion vector candidates assigned to pixel blocks located outside the currently processed region in a first motion estimation pass, the quality of a motion estimation algorithm after the second or further motion estimation pass is improved in comparison with prior-art solutions.

The present invention relates to the field of video processing. In particular, it relates to the field of motion estimation. Specifically, the invention relates to a video-processing method and device ascertaining motion vectors for a plurality of first pixel blocks forming a currently processed image of a currently processed image of an image sequence.

In video processing, motion estimation (ME) is a widely used task. One class of ME methods and devices employs block-matching ME algorithms. A block-matching ME algorithm ascertains a motion vector to each pixel block of an image forming a part of an image sequence. A pixel block has predetermined numbers of pixels in x- and y-directions of an image. A motion vector represents the motion of a pixel block between two consecutive images of the image sequence. A block-matching ME algorithm ascertains a motion vector by finding for each pixel block of a currently processed image a similar block in a previous image of the image sequence.

Video-processing devices employing ME are used in television devices, for instance for De-interlacing and picture-rate up-conversion applications. ME is also used for video data encoding.

Currently, there is a trend to increasing display sizes in consumer-electronics video devices. The High Definition Television (HDTV) standard requires about 2 Megapixels per frame. Running ME for such frame sizes has become a challenging task, the trend going towards even bigger sizes of 8 Megapixels per frame. This image size must be supported by the processor, memory and communication architecture.

It is noted that the term “image” is used herein with a general meaning comprising any representation of an image by pixel data. The terms “frame” and “field”, which are used in the art with specific meanings for respective digital representations of an image, are comprised by the term “image” as used herein. Also, slight variations of these terms, such as “video frame” instead of “frame” are used herein with identical meaning.

The document A. Berić, R. Sethuraman, J. van Meerbergen, G. de Haan, “Algorithm/Architecture co-design of a picture-rate up-conversion module”, Proceedings of ProRISC conference November 2002, pages 203-208, describes an architecture to increase the bandwidth of the memory subsystem of a video-processing device. An image frame is fragmented into regions. A two-level buffering of pixel data of an image is proposed. A high-level scratchpad, also referred to as L1 scratchpad, holds one image region of the currently processed image and the corresponding image region of the preceding image. Each image region of the currently processed image is processed independently. A low-level scratchpad, also referred to as a L0 scratchpad, holds a current search area used by a motion estimator. The search area forms a sub-array of the image containing pixel blocks of the current image region in the currently processed image and in a corresponding, identically positioned image region in the preceding image. The motion estimator tests a number of motion vector candidates. Video data is derived from the search area for each of the motion vector candidates.

Because of the causality problem, motion vector candidates are selected not only from the pixel blocks of a currently processed image, but from two consecutive images. That is, some motion vectors of the currently processed image are not available yet for serving as motion vector candidates when processing a particular first pixel block of an image region. For such missing motion vector candidates, the motion vectors provided by the corresponding second pixel blocks of a previous image are selected. A motion vector candidate that was ascertained for a second pixel block in the preceding image is known in the art as a temporal motion vector candidate. It will also be referred to as temporal candidate or temporal candidate vector herein. “Corresponding” means in this context, that the position of the pixel block providing the temporal motion vector candidate is identical to that of the pixel block in the currently processed image. As is well known, a position of a pixel block in an image can be defined by matrix coordinates.

The region-based approach reduces the bandwidth requirements toward the frame memory holding a video frame. It offers the possibility of performing multiple ME scans, also referred to as ME passes, within the region without having to access the main memory, which is typically located externally in regard to the motion estimator.

However, the region-based approach causes problems when performing ME at the boundaries between regions. For data that lies outside the currently processed region is not taken into account in the ME on the particular image region. This introduces a quality loss.

It is therefore an object of the invention to provide a video-processing method and device that enhances the quality of region-based motion estimation.

According to a first aspect of the invention, a video-processing device is provided, comprising a processing unit, which is adapted
to ascertain motion vectors for a plurality of first pixel blocks, which form a currently processed image region of a currently processed image of an image sequence, proceeding from image region to image region and processing a respective image region at least twice before proceeding to a next image region,
to ascertain a motion vector for a currently processed first pixel block of the image region by evaluating a respective set of candidate motion vectors containing at least one temporal candidate vector, which is a motion vector that was ascertained for a second pixel block of a preceding image of the image sequence, and
to update, before processing a respective image region of the currently processed image a second time, a temporal candidate vector, which is contained in a set of candidate motion vectors for a first pixel block of the currently processed image region and was ascertained for a third pixel block located outside the currently processed image region in the preceding image, by ascertaining a motion vector for the pixel block corresponding to the third pixel block in the currently processed image and replacing the temporal candidate vector with it.

According to the present invention, multiple ME passes are performed for each image region, thus increasing the quality of motion estimation over a single-pass ME algorithm. Furthermore, the concept of region-based ME is extended and enhanced in the present embodiment by enabling the processing unit to ascertain motion vectors for those second pixel blocks of the currently processed image, which are located outside a currently processed image region, but whose respective predecessor at the corresponding location in the preceding image are used for providing temporal motion vector candidates. Such pixel blocks in the preceding image are referred to as “third pixel blocks” herein. However, to keep the terminology of the present specification simple, the term “third pixel block” will also be used to refer to the corresponding pixel block in the currently processed image. It is clear for the person skilled in the art, that updating a temporal candidate of a third pixel block means ascertaining a motion vector for a pixel block in the currently processed image, which is identically positioned as the third pixel block in the preceding image, which provides the temporal motion vector candidate.

It is also noted that, strictly speaking, the “currently processed image region” might be interpreted to comprise not only the first pixel blocks, but also such third pixel blocks, because they are included in the ME processing of a respective image region. However, in order to keep the terminology clear, the term “currently processed image region” shall be used herein consistently to include only the (core) image region formed by the first pixel blocks, and not the region extension, which is formed by the additionally processed third pixel blocks.

Furthermore, the invention does not comprise a recursion in updating temporal motion vector candidates, in the sense that temporal motion vector candidates are updated, which are used for updating a temporal motion vector candidate and which are also located outside the currently processed region.

By updating also temporal candidates for third pixel blocks in the first ME pass, the influence of region borders is reduced in the second ME pass, and, consequently, the quality of region-based ME is increased.

In the following, preferred embodiments of the video-processing device of the invention will be described.

According to a first embodiment, the processing unit is adapted to ascertain motion vectors proceeding from first pixel block to the next first pixel block within a currently processed image region according to a predetermined scan order, and to process a current image region at least twice using identical scan orders. An example of a scan order is following pixel blocks from left to right in each pixel-block line, and following pixel lines from top to bottom in the image region. Many different scan orders are known in the art, some of them having a meandering pattern.

In an alternative embodiment the processing unit is adapted to ascertain motion vectors proceeding from first pixel block to the next first pixel block according to a predetermined scan order within a currently processed image region, and to process a current image region at least three times using at least two different scan orders. Different scan orders are thus preferably used when processing an image region at least three times. The first and last motion estimation passes are in one embodiment identical and follow a scan order from top to bottom in order to make a buffer memory between a motion estimator and a motion compensator arranged downstream unnecessary.

In a further embodiment of the video-processing device of the invention, the processing unit is adapted
to process an image according to a fragmentation into a number of image regions, each image region containing pixel blocks shared by a first number of pixel-block columns and a second number of pixel-block lines according to an adjustable aspect ratio, and
to set a different aspect-ratio value for processing a next image of the image sequence, such that the number of image regions per image remains constant.

The video-processing device of the invention allows including different parts of an image in the convergence process of an implemented region-based ME algorithm. It therefore removes fixed borders between neighboring image regions for the purpose of motion estimation.

The present embodiment is based on the concept of changing the aspect ratio of the image regions, which form a zoning of an image, when proceeding with motion estimation from a currently processed image to a following image. The ratio of the first number of pixel-block lines and the second number of pixel-block columns, which share the pixel blocks of an image region, defines the aspect ratio of that image region.

By changing the aspect ratio of an image region without changing the number of image regions per image, the area of one image region in the image remains constant. It is only the first number of pixel-block lines and the second number of pixel-block columns that are changed.

The present embodiment achieves the advantage that there are no more prominent signs of borders between neighboring image regions in the output of the video-processing device. The video-processing device of the present embodiment thus allows to further diminish the difference in quality of motion estimation between a device implementing a region-based motion estimation algorithm and a device implementing a so called full-search algorithm. A full-search algorithm scans all pixel-blocks of an image to determine the motion vector for a particular first pixel block. While the problem of borders between regions cannot occur in a full-search ME algorithm, it is slow and inefficient, and thus not preferred for implementation in video-processing devices.

In a further embodiment, the processing unit comprises a fragmentation unit, which is adapted to ascertain a set of aspect ratio values, which leave the number of image regions per image constant, and to select a different aspect-ratio value from this set for processing a next image.

Minimizing the memory bandwidth requirement is a design constraint that strongly influences the choice of aspect ratios used. The choice of aspect ratios used should further be made with a view to the video application, for which the video-processing device is used. In some video processing applications it would not be useful to choose an aspect ratio, according to which an image region covers only the height or the width of one search area, or even less. Preferably, the aspect ratio of an image region in ME applications should be selected large enough in both x- and y-directions to allow including the search areas required for determining motion vectors for the first and third pixel blocks contained in the currently processed image region. This will be explained in more detail further below in the context of another embodiment with reference to the figures.

It is noted that the determination of the aspect ratio is in one embodiment based on the numbers of pixel-block lines and columns sharing the sub-array loaded into the L1 scratchpad. Of course, this implicitly defines a value of the aspect ratio of the image region, given the extension of the search area in x- and y-directions, and the relative position of respective temporal motion vector candidates for a currently processed pixel block.

In other applications, however, an aspect ratio may be useful, which covers only the height of width of one search area. Inage regions forming of that size and aspect ratio, can for instance be used in picture-rate up conversion applications.

In a further embodiment, the fragmentation unit is adapted to select the number of image regions per image such that the set of aspect ratio values contains at least a predetermined number of entries.

In a further embodiment, the fragmentation unit is adapted to set the number of image regions per image in dependence on a video format of the image sequence.

A further embodiment of the video-processing device of the invention comprises
a high-level scratchpad connected to the processing unit, and
a memory control unit, which is connected to the processing unit and the high-level scratchpad, and which is connectable to an external image memory and adapted to load from the external image memory into the high-level scratchpad identically positioned sub-arrays of each the two consecutive images, each sub-array spanning at least the currently processed image region.

As explained in the introductory part of the present specification, a buffering of the image region in a scratchpad-type memory reduces the bandwidth requirements data bus between the video-processing device according to the invention and a main memory containing the complete set of pixel data of a currently processed image. It allows performing multiple ME scans per image region without requiring any additional access to the main memory.

In a further embodiment of the invention, the processing unit comprises a motion estimator, which is adapted to ascertain a motion vector for a respective first pixel block by evaluating pixel-block similarity between the first pixel block and respective fourth pixel blocks, which are selected from an image pair formed by consecutive images comprising the currently processed image and which are defined by a respective set of candidate motion vectors. This embodiment implements a particular block-matching ME method. The pixel blocks, from which motion vector candidates are selected are typically located in a defined position relative to the currently processed first pixel block. In one embodiment, the processing unit is adapted to change the position of these pixel blocks, in order to use different motion vector candidate sets.

In a preferred embodiment motion vector candidates comprise temporal candidates, as described above, and spatial candidates, also as spatial motion vector candidates herein. Spatial candidate vectors are motion vectors that have been ascertained for pixel blocks, which typically form direct spatial neighbors of the currently processed first pixel block.

In a further embodiment, the processing unit is adapted to ascertain a motion vector for a respective first pixel block by scanning a respective search area, which forms a predetermined sub-array of the currently processed image.

In a further embodiment, the memory control unit is adapted to load into the high-level scratchpad a sub-array of the image that exceeds the currently processed image region by pixel blocks of a third number of pixel-block lines and a fourth number of pixel-block columns, such that the sub-array contains all respective search areas for first pixel-blocks, which are located at an edge of the current image region. The third number of pixel-block lines is preferably half the number of pixel-block lines per search area. The fourth number of pixel-block columns is preferably half the number of pixel-block columns per search area.

In a further embodiment of the video-processing device of the invention, the memory control unit is adapted to load into the high-level scratchpad a sub-array of the image exceeding a respective currently processed image region by pixel blocks of a fifth number of pixel-block lines and a sixth number of pixel-block columns, such that all respective search areas are loaded into the high-level scratchpad, which are needed for updating temporal vector candidates provided by the respective third pixel blocks.

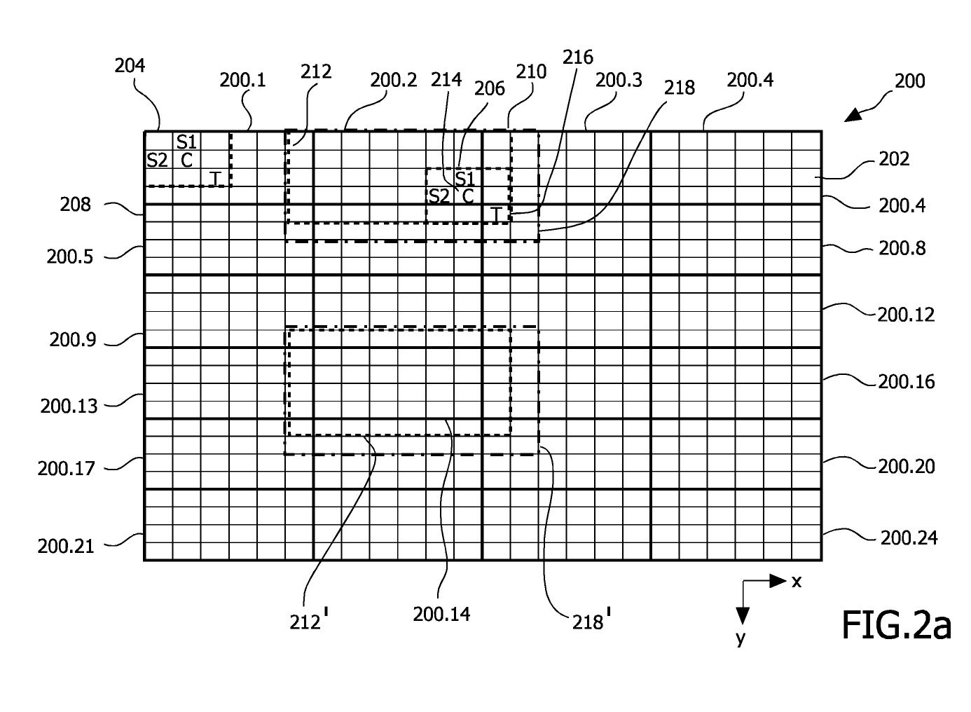

The extension of the region size used in the present embodiment is preferably determined by the distance of the third pixel block, which provides the temporal motion vector and which is located outside the currently processed image region, to the respective currently processed first pixel block at the edge of the image region. An illustrative example will be given below with reference to FIGS. 2a and 2b.

In a further embodiment, the video-processing device comprises a low-level scratchpad, which is arranged between the processing unit and the high-level scratchpad and adapted to store an identically positioned respective search area of each of the two consecutive images.

Preferably, the memory control unit is adapted to fetch a current search area from the high-level scratchpad to the low-level scratchpad.

In a further embodiment of the video-processing device, the processing unit comprises a prediction memory connected to the motion estimator and containing spatial and temporal candidate vectors. Preferably, the processing unit is adapted to store a respective ascertained motion vector for a respective first pixel block in the prediction memory, possibly updating a previously stored motion vector for the respective first or third pixel block.

According to a second aspect of the invention a video-processing method is provided, comprising the steps of
ascertaining motion vectors for a plurality of first pixel blocks, which form a currently processed image region of a currently processed image of an image sequence, proceeding from image region to image region and processing a respective image region at least twice before proceeding to a next image region,
ascertaining a motion vector for a currently processed first pixel block of the image region by evaluating a respective set of candidate motion vectors containing at least one temporal candidate vector, which is a motion vector that was ascertained for a second pixel block of a preceding image of the image sequence, and
updating, before processing a respective image region of the currently processed image a second time, a temporal candidate vector, which is contained in a set of candidate motion vectors for a first pixel block of the currently processed image region and was ascertained for a third pixel block located outside the currently processed image region in the preceding image, by ascertaining a motion vector for the third pixel block in the currently processed image and replacing the temporal candidate vector with it.

The features and advantages of the video-processing method of the second aspect of the invention correspond to those described above with reference to the video-processing device of the first aspect of the invention.

In the following preferred embodiments of the video-processing method of the invention will be described. Since the embodiments of the method of the invention correspond to embodiments of the inventive processing device, no detailed explanation will be given here. Reference is made to the above description of the embodiments of the video-processing device of the first aspect of the invention.

It is noted that, unless otherwise stated, the embodiments of the video-processing method of the invention can be combined with each other.

In one embodiment of the video-processing method of the invention, ascertaining motion vectors for a plurality of first pixel blocks is performed proceeding from first pixel block to the next first pixel block within a currently processed image region according to a predetermined scan order. At least two passes of the currently processed image regions are performed using identical scan orders. In an alternative embodiment at least three passes are performed using at least two different scan orders.

In another embodiment, the video-processing method of the invention comprises the steps of
processing an image according to a fragmentation into a number of image regions, each image region containing pixel blocks shared by a first number of pixel-block columns and a second number of pixel-block lines according to an adjustable aspect ratio, and
setting a different aspect-ratio value for processing a next image of the image sequence, such that the number of image regions per image remains constant.

In a further embodiment, the video-processing method of the invention comprises the steps of
ascertaining a set of aspect ratio values, which leave the number of image regions per image constant, and of
selecting a different aspect-ratio value from this set for processing a next image.

Ascertaining an aspect ratio value comprises in one embodiment factorizing the given number of image regions per image into a plurality of factors, grouping the plurality of factors into two groups, and calculating partial products of the factors for each group to obtain the numbers of pixel-block lines and pixel-block columns sharing one image region, thus defining an aspect ratio value. The grouping is varied in one embodiment to obtain a different aspect ratio value.

In a further embodiment, the number of image regions per image is selected such that the set of aspect ratio values contains at least a predetermined number of entries.

In a further embodiment, the video-processing method of the invention comprises a step of fetching from an image memory into a high-level scratchpad identically positioned sub-arrays of each the two consecutive images, each sub-array spanning at least the currently processed image region.

In another embodiment, the video-processing method of the invention, the step of ascertaining a motion vector for a respective first pixel block comprises evaluating pixel-block similarity between the respective first pixel block and pixel blocks, which are selected from an image pair formed by consecutive images comprising the currently processed image and which are defined by the respective set of candidate motion vectors.

Preferably, in ascertaining a motion vector for a respective first pixel block a respective set of candidate motion vectors containing also spatial candidate vectors is used.

In a further embodiment of the video-processing method of the invention respective motion vectors are ascertained by scanning the first pixel blocks of a currently processed image region with a predetermined scan order.

In a further embodiment of the video-processing method of the invention, ascertaining a motion vector for a respective first pixel block comprises scanning a respective search area, which forms a predetermined sub-array of the image.

In a further embodiment of the video-processing method of the invention, a sub-array of the image that exceeds the currently processed image region by a third number of pixel-block lines and a fourth number of pixel-block columns is loaded into the high-level scratchpad, such that the sub-array contains all respective search areas for first pixel-blocks, which are located at an edge of the current image region. The third number of pixel-block lines is preferably the half the number of pixel-block lines per search area. The fourth number of pixel-block columns is preferably the half the number of pixel-block columns per search area.

In a further embodiment of the video-processing method of the invention, a step of loading into a low-level scratchpad an identically positioned respective search area of each of the two consecutive images is performed. The low-level scratchpad is arranged between the processing unit and the high-level scratchpad. In a further embodiment of the video-processing method of the invention, the memory control unit is adapted to fetch the current search area from the high-level cache memory to the low-level cache memory, without having to access an external image memory.

In one embodiment of the video-processing method of the invention, a step of storing an ascertained motion vector for a respective first pixel block in the prediction memory is performed, such that a previously stored motion vector for the respective first pixel block is updated if the prediction memory contained a motion vector assigned to this pixel block before.

In another embodiment of the video-processing method of the invention, a sub-array of the image exceeding a respective currently processed image region by pixel blocks of a fifth number of pixel-block lines and a sixth number of pixel-block columns is loaded into the high-level scratchpad, such that all respective search areas are loaded, which are needed for updating temporal vector candidates provided by respective third pixel blocks, which are located outside the currently processed image region.

A third aspect of the invention is formed by a data medium, which contains a code for controlling the operation of a programmable processor in performing a video-processing method, the method comprising the steps of
ascertaining motion vectors for a plurality of first pixel blocks, which form a currently processed image region of a currently processed image of an image sequence, proceeding from image region to image region and processing a respective image region at least twice before proceeding to a next image region,
ascertaining a motion vector for a currently processed first pixel block of the image region by evaluating a respective set of candidate motion vectors containing at least one temporal candidate vector, which is a motion vector that was ascertained for a second pixel block of a preceding image of the image sequence, and
updating, before processing a respective image region of the currently processed image a second time, a temporal candidate vector, which is contained in a set of candidate motion vectors for a first pixel block of the currently processed image region and was ascertained for a third pixel block located outside the currently processed image region in the preceding image, by ascertaining a motion vector for the pixel block corresponding to the third pixel block in the currently processed image and replacing the temporal candidate vector with it.

In various embodiments of the data medium of the third aspect of the invention the computer code is adapted to control the operation of a programmable processor for performing a respective embodiment of the video-processing method of the second aspect of the invention.

In the following, further embodiments of the video-processing method and device of the invention will be described with reference to the enclosed figures.

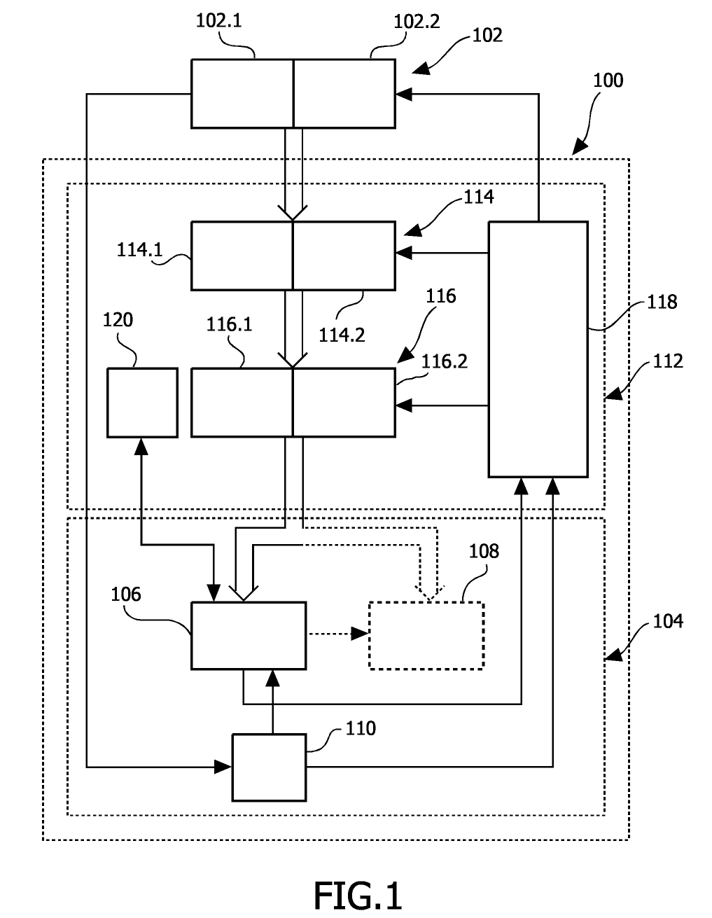

FIG. 1 shows a block diagram of a preferred embodiment of a video-processing device.

FIGS. 2a and 2b illustrate further preferred embodiments of the video-processing method and device of the invention.

FIG. 1 shows a block diagram of a video-processing device 100, which is connected to an external frame memory 102. Video-processing device 100 is preferably implemented in the form of an application specific instruction set processor (ASIP). ASIPs offer a flexible, low-cost and low-power implementation of video processing algorithms.

Other embodiments of video-processing device 100 take the form of an application specific integrated circuit (ASIC) or of a general purpose programmable processor, in which the video processing application is performed by a software. However, the lack of flexibility of ASICs and the slow performance of a general purpose programmable processor implementation make the ASIP implementation appear as the most advantageous for the purposes of commercial application in consumer electronics devices such as television sets.

A processing unit 104 of video-processing device 100 comprises a motion estimator 106. In different embodiments, an additional processing section 108 is comprised by processing unit 104. Processing section 108 may be a motion compensator. Processing unit 104 further contains a fragmentation unit 110.

Video-processing device 100 further contains a memory subsystem 112 comprising a high-level scratchpad 114, a low-level scratchpad 116 and a memory controller 118. The memory subsystem 112 is connected with processing unit 104 and has an interface for connection with external frame memory 102.

The high-level scratchpad 114, which is also referred to as L1 scratchpad, is divided into two sections 114.1 and 114.2, each having a memory capacity to store a sub-array of an image stored in corresponding memory sections 102.1 and 102.2 of main memory 102.

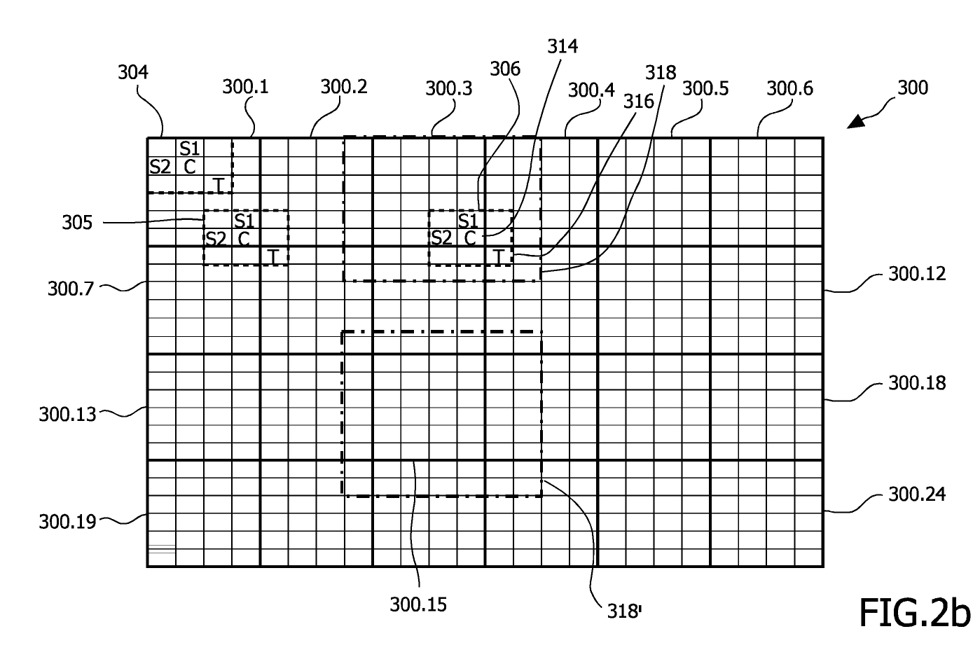

Low-level scratchpad 116 is also divided into two sections 116.1 and 116.2. The storage capacity of each scratchpad section is chosen to fit a search area used by the motion estimator 106 to obtain a motion vector for a currently processed pixel block, as will be explained in more detail with reference to FIGS. 2 and 3. Low-level scratchpad 116 is also referred to as L0 scratchpad. Memory controller 118 is connected to the L1 and L0 scratchpads 114 and 116 and controls the flow of image data from external memory 102 to motion estimator 106. In one embodiment the control operation of memory controller 118 is dependent on control data received from motion estimator 106 and fragmentation unit 110, as will be explained in the following.

In the embodiment shown in FIG. 1, memory subsystem 112 further comprises a prediction memory, which temporarily stores motion vectors ascertained by motion estimator 106.

During operation, two consecutive images stored in memory sections 102.1 and 102.2 of main memory 102 are used to determine motion vectors for each pixel block of a currently processed image. For illustration purposes, it is assumed that the memory section 102.2 contains a currently processed image and memory section 102.1 contains an image immediately preceding that stored in section 102.2 in an image sequence.

Memory controller 118 loads identically positioned sub-arrays of the image pair stored in main memory 102 into L1 scratchpad 114. The size of the sub-arrays will be explained in detail below with reference to FIGS. 2 and 3. Furthermore, memory controller 118 fetches a current search area of both sub-arrays stored in L1 scratchpad sections 114.1 and 114.2 into L0 scratchpad sections 116.1 and 116.2.

Motion estimator 106 uses the search areas stored in L0 scratchpad sections 116.1 and 116.2 to ascertain a motion vector for a currently processed pixel block of the video image stored in main memory 102.2. The operation of motion estimator 106 will also be explained in more detail with reference to FIGS. 2 and 3.

The fragmentation unit 110 comprised by processing unit 104 provides control data to memory controller 118 and motion estimator 106. The control data instruct memory controller 118 and motion estimator 106 about the aspect ratio of the image regions, which are processed sequentially by the motion estimation algorithm performed by motion estimator 106. Memory controller 118 uses the control data received from fragmentation unit 110 to determine the size of the sub-array of the images stored in main memory 102 to be fetched into L1 scratchpad 114. Motion estimator 106 uses the control data received from fragmentation unit 110 to determine the coordinates of the pixel blocks to be processed as a part of the currently processed image region. The control data received from fragmentation unit 110 instruct motion estimator 106 about when a motion estimation pass of an image region is completed.

Video-processing device 100 is a motion estimation device. However, motion estimation is used in various video processing tasks such as motion compensated filtering for noise reduction, motion compensated prediction for coding, and motion compensated interpolation for video format conversion. Depending on the application purpose, video-processing device 100 may form a part of a more complex video-processing device. In an embodiment comprising a motion compensator 108, a motion vector ascertained by motion estimator 106 is provided as an input to motion compensator 108 for further processing. Motion compensator 108 is shown by dashed lines to indicate that it is an optional addition. processing sections performing other tasks, which uses motion vectors as an input may take the place of motion compensator 108.

Further details of the operation of video-processing device 100 will next be set forth with reference to FIGS. 2a and 2b, which also serve to illustrate different embodiments of the video-processing method of the invention.

FIG. 2a shows a video frame 200, which is formed by an array of pixels, which are grouped into pixel blocks. Only pixel blocks are shown in FIG. 2a. Their borders are represented by a grid in FIG. 2a. An example of a pixel block is marked with reference label 202. A pixel block may for instance contain a sub-array of 8×8 pixels of video frame 200.

Motion estimator 106 is adapted to ascertain a motion vector for each pixel block of video frame 202. Motion estimator 106 performs a region-based motion estimation algorithm. That is, motion vectors are sequentially ascertained for the pixel blocks of a currently processed image region forming a sub-array of image 200. In FIG. 2a, the borders between neighboring image regions are indicated by bold lines. Image 200 is fragmented into 24 image regions 200.1 to 200.24. In the present example chosen for illustration purposes, each image region contains 6 pixel blocks in x-direction and 4 pixel blocks in y-direction. In real-life applications, the number of pixel blocks per image region may be much higher.

In processing an image region, motion estimator 106 proceeds from pixel block to pixel block of the currently processed image region according to a predetermined scan order. The pixel blocks of an image region are also called first pixel blocks herein. In ascertaining a motion vector for a currently processed pixel block C, it uses a respective search area centered around pixel blocks C. Two examples of search areas are shown by dashed border lines at reference labels 204 and 206. Search areas 204 and 206 form a sub-array of the image 200 of predefined extension in x- and y-directions. In the present illustrative example, a search area comprises 3×3 pixel blocks. Another example of search area used in commercial devices consists of 9 pixel-block lines by 5 pixel-block columns.

As can be seen from FIG. 2a, each currently processed pixel block C has an individual search area, which is used for determining the motion vector for pixel block C.

The example of search area 206 shows that a search area for pixel blocks at the border of an image region extends beyond the respective image region. In the case of search area 206, a number of pixel blocks taken from one pixel block column to the right of image region 200.2 and one pixel block line below image region 200.2 are needed to cover all search areas needed to ascertain the motion vectors for border pixel blocks like that in the center of search area 206. In one embodiment of the invention, the corresponding sections of pixel-block line 208 and pixel-block column 210 are fetched from main memory 102 in addition to the pixel blocks of image region 200.2. The complete sub-array of image 200 loaded into L1 scratch pad 114 in this embodiment is shown by a dotted line 212 for the examples of image region 200.2 and image region 200.14. Inage region 200.14 is located in the middle of image 200 while image region 200.2 is located at an edge.

For ascertaining a motion vector, preferably a three-dimensional recursive search motion estimation algorithm is used, which will be referred to as the 3DRS ME algorithm in the following and is well known in the art. According to this and similar algorithms, a motion vector is ascertained for a current pixel block C using a set of candidate motion vectors. The set of candidate motion vectors contains spatial motion vector candidates of recently processed pixel blocks of the currently processed image, marked by S₁ and S₂ in FIG. 2a. In addition, temporal motion vector candidates are used. The pixel blocks, from which temporal motion vector candidates are used, are marked by the reference label T in search areas 204, 206, and 304, 306 shown in FIGS. 2a and 2b.

The position of the pixel blocks, from which spatial and temporal motion vector candidates are used, is preset in relation to the respective currently processed pixel block C. As can be seen in the example of FIG. 2a, the two spatial motion vector candidates are selected from the pixel blocks S₁ and S₂, which are located one block to the left and one block above the currently processed pixel block. The temporal motion vector candidate is used from the pixel block T of the previous image, which is located one block below and one block to the right of the currently processed pixel block C. In the description given earlier, pixel blocks T are generally referred to as second pixel blocks. The relative position of the second pixel blocks T, is adjustable in one embodiment, so that motion estimator 106 can use different relative positions, for instance for different video processing applications.

In a preferred embodiment, which will now be described in more detail, temporal motion vector candidates, which are selected from pixel blocks T located outside the currently processed region, are also updated. These particular pixel blocks are referred to as third pixel blocks herein. A situation typical for this embodiment is represented by search area 206 for a currently processed pixel block 214 located at the lower right corner of image region 200.2. The temporal candidate T used for ascertaining a motion vector for pixel block 214 of the currently processed pixel block 10 is taken from pixel block 216 of the preceding image. Pixel block 216 thus forms a third pixel block. According to the present embodiment, a motion vector for pixel block 216 is ascertained in the same way as for all first pixel blocks contained in image region 200.2. This way, an updated motion vector candidate can be used for processing pixel block 214 in a second motion estimation pass of image region 200.2. This further improves the quality of the region based motion estimation.

For updating the temporal candidate vectors, which are taken from third pixel blocks of the previous image and located outside the currently processed image region, an extended sub-array of image 200 is loaded into L1 scratchpad 114. The extended sub-array is marked by a dash-dotted line 218 in FIG. 2a). A second example for this extended type of sub-array is given for image region 200.14, marked which reference label 218′. The extended sub-arrays 218, 218′ include all search areas, which are needed to update the temporal motion vectors of pixel blocks located outside the respective image region, that is in other words, to replace the temporal candidates by respective spatial motion vector candidates. Therefore, the size of the sub-arrays 218, 218′ depends on the location of the third pixel blocks, such as pixel block 216, providing temporal motion vector candidates with respect to the currently processed pixel block C. If the temporal motion vector candidate is taken from a third pixel block, which is more distant from the currently processed pixel block C, a larger number of pixel-block line sections and/or pixel-block column sections is loaded into L1 scratchpad 114.

Image frame 200 is thus processed according to one of the embodiments described above, preceding from image region to image region, until motion vectors have been ascertained for all pixel blocks of image regions 200.1 through 200.24 of image 200.

The ratio between the number of pixel-block lines and pixel-block columns of each image region 200.1 to 200.24 defines an aspect ratio of the image regions. In the present example, the aspect ratio is 4/6 or 0.66.

Given the exemplary number of 24 image regions per image, fragmentation unit 110 in one embodiment factorizes this number into prime numbers for ascertaining different aspect ratio values. As is well known, 24=1*2*2*2*3. This allows the grouping of the prime numbers into two factors, defining the following possible combinations of image regions in x- and y-directions: 1 image region in x-direction times (x) 24 image regions in y-direction, 24×1, 2×12, 12×2, 3×8, 8×3, 4×6, and 6×4. In order to allow fragmentation unit 110 as much flexibility as possible, the number of image regions per image should be chosen as factorably as possible.

According to the preferred embodiment of the present invention, before switching to ascertaining motion vectors for the next image 300 in the processed image sequence (FIG. 2b), the fragmentation unit 110 instructs motion estimator 106 and memory controller 118 to use a different value of the aspect ratio of the image regions for processing image 300. As can be seen from FIG. 2b, the aspect ratio used in this example is the inverse of that used for image 200, i. E. 6/4 or 1.5. The aspect ratio is chosen to leave the numbers of image regions in image 300 unchanged in comparison to the number of image regions in image 200. Both consecutive images contain 24 image regions.

Memory controller 118 thus loads different sub-arrays into L1 scratchpad 114. For illustration purposes, search areas 304 and 306 are shown. Search area 304 exactly corresponds to search area 204. Search area 306 shows a similar situation as search area 206, but the corresponding currently processed pixel block 314 differs in location from pixel block 214 due to the changed aspect ratio used for processing image 300. Consequently, the sub-array 312, 312′ and 318, 318′ differ according to the position and aspect ratio of the corresponding image regions 300.3 and 300.15.

The sections above were based on an image size used mainly for illustrative purposes. The following preferred embodiments are used on the basis of the embodiments set forth above for processing video sequences according to the standard-definition television (SDTV) and high-definition television (HDTV) standards.

In SDTV, the image size is 720*576 pixels, which is the resolution used in most television sets in Europe today. In total, an image is fragmented into 35 image regions. Two different aspect ratios used are. The preferred pixel-block size in this case is 8*8 pixels. One preferred size of the subarray loaded into the L1 scratchpad and containing one image region plus all additional pixel blocks needed for search areas of pixel blocks on the edge of the respective image region is 25*14 pixel blocks. Two preferred aspect ratios of the subarrays are 25/14 and 14/25. Due to an overlap of neighboring sub-arrays, this means that there are 5 image regions horizontally and 7 image regions vertically. The size of the search area is 9*5 blocks.

In HDTV, the image size is 1920*1080 pixels. The preferred pixel-block size is 8*8 pixels. In one embodiment, a total of 20 image regions per image is used. A preferred size of the subarray loaded into the L1 scratchpad and containing one image region plus all additional pixel blocks needed for search areas of pixel blocks on the edge of the respective image region is 66*31 pixel blocks, which means that there are 4 regions horizontally and 5 vertically. Two preferred aspect ratios of the subarrays are 66/31 and 31/66. That corresponds to aspect ratios. Again, these numbers take into account the overlap between neighboring subarrays. The size of the search area is again 9*5 blocks.

In determining the region size care should be taken not to have too many image regions, since a large number reduces the ME quality. On the other hand, a too small number of image regions lets the size of the image regions become problematically high, due to an increase of the bandwidth requirements in the connection between the L1 scratchpad and the external image memory. The dimensions of the image regions should further be chosen so that the size of all image regions can be made at least approximately equal. Here, one needs to take into account the size of the search area due to the overlap of neighboring sub-arrays loaded into the L1 scratchpad.

The use of different aspect ratios further improves the quality of motion estimation since it removes virtually all signs of the borders of the image regions in the output of motion estimator 106, and thus, also in the output of the motion compensator 108 arranged downstream of motion estimator 106.

1. A video-processing device (100), comprising a processing unit (104), which is adapted
to ascertain motion vectors for a plurality of first pixel blocks (C), which form a currently processed image region (200.1 to 200.24; 300.1 to 300.24) of a currently processed image (200, 300) of an image sequence, proceeding from image region to image region and processing a respective image region at least twice before proceeding to a next image region,
to ascertain a motion vector for a currently processed first pixel block (C) of the image region by evaluating a respective set of candidate motion vectors containing at least one temporal candidate vector, which is a motion vector that was ascertained for a second pixel block (T) of a preceding image of the image sequence, and
to update, before processing a respective image region (200.1 to 200.24; 300.1 to 300.24) of the currently processed image a second time, a temporal candidate vector, which is contained in a set of candidate motion vectors for a first pixel block (214) of the currently processed image region (200.2) and was ascertained for a third pixel block (216) located outside the currently processed image region (200.2) in the preceding image, by ascertaining a motion vector for the pixel block corresponding to the third pixel block (216) in the currently processed image and replacing the temporal candidate vector with it.

2. The video-processing device of claim 1, wherein the processing unit (104) is adapted to ascertain motion vectors proceeding from pixel block (202) to pixel block within a currently processed image region according to a predetermined scan order, and to process a current image region at least twice using identical scan orders.

3. The video-processing device of claim 1, wherein the processing unit (104) is adapted to ascertain motion vectors proceeding from pixel block (202) to pixel block according to a predetermined scan order within a currently processed image region (200.2), and to process a current image region at least three times using at least two different scan orders.

4. The video-processing device of claim 1, wherein the processing unit (104) is adapted
to process an image (200) according to a fragmentation into a number of image regions (200.1 to 200.24), each image region containing pixel blocks shared by a first number of pixel-block columns and a second number of pixel-block lines according to an adjustable aspect ratio, and
to set a different aspect-ratio value for processing a next image (300) of the image sequence, such that the number of image regions (300.1 to 300.24) per image remains constant.

5. The video-processing device of claim 4, wherein the processing unit (104) comprises a fragmentation unit (110), which is adapted to ascertain a set of aspect ratio values, which leave the number of image regions (200.1 to 200.24; 300.1 to 300.24) per image constant, and to select a different aspect-ratio value from this set for processing a next image (300).

6. The video-processing device of claim 5, wherein the fragmentation unit is adapted to select the number of image regions per image such that the set of aspect ratio values contains at least a predetermined number of entries.

7. The video-processing device of claim 5, wherein the fragmentation unit is adapted to set the number of image regions per image in dependence on a video format of the image sequence.

8. The video-processing device of claim 1, further comprising
a high-level scratchpad (114) connected to the processing unit (104), and
a memory control unit (118), which is connected to the processing unit (104) and the high-level scratchpad (114), and which is connectable to an external image memory (102) and adapted to load from the external image memory into the high-level scratchpad identically positioned sub-arrays (218, 218′; 318, 318′) of each the two consecutive images (200, 300), each sub-array comprising the currently processed image region (200.2, 200.14; 300.3, 300.15) and all pixel-blocks outside the currently processed region, which are required for ascertaining a motion vector for the third pixel block (216, 316) in the currently processed image (200, 300).

9. The video-processing device of claim 1, wherein the processing unit (104) comprises a motion estimator (106), which is adapted to ascertain a motion vector for a respective first pixel block (C) by evaluating pixel-block similarity between the first pixel block (C) and respective pixel blocks, which are selected from an image pair (200, 300) formed by consecutive images comprising the currently processed image and which are defined by a respective set of candidate motion vectors.

10. The video-processing device of claim 1, wherein the processing unit (104) is adapted to ascertain a motion vector for a respective first pixel block (C) by scanning a respective search area (204, 206, 304, 305, 306), which forms a predetermined sub-array of the currently processed image.

11. The video-processing device of claim 9, wherein the memory control unit (118) is adapted to load into the high-level scratchpad (114) a sub-array (218, 218′; 318, 318′) of the image that exceeds the currently processed image region by a third number of pixel-block lines and a fourth number of pixel-block columns, such that the sub-array contains all respective search areas for first pixel-blocks, which are located at a border of the currently processed image region.

12. The video-processing device of claim 9, wherein the memory control unit (118) is adapted to load into the high-level scratchpad (114) a sub-array (218, 218′; 318, 318′) of the image exceeding a respective currently processed image region (200.2, 200.14; 300.3, 300.15) by pixel blocks of a fifth number of pixel-block lines and a sixth number of pixel-block columns, such that all respective search areas are loaded into the high-level scratchpad (114), which are needed for updating temporal vector candidates provided by respective third pixel blocks (216, 316).

13. The video-processing device of 8, further comprising a low-level scratchpad (116), which is arranged between the processing unit (104) and the high-level scratchpad (114) and adapted to store an identically positioned respective search area (204, 304) of each of the two consecutive images (200, 300).

14. A video-processing method comprising the steps of
ascertaining motion vectors for a plurality of first pixel blocks (202), which form a currently processed image region (200.1 to 200.24; 300.1 to 300.24) of a currently processed image (200, 300) of an image sequence, proceeding from image region to image region and processing a respective image region at least twice before proceeding to a next image region,
ascertaining a motion vector for a currently processed first pixel block (C) of the image region by evaluating a respective set of candidate motion vectors containing at least one temporal candidate vector, which is a motion vector that was ascertained for a second pixel block (T) of a preceding image of the image sequence, and
updating, before processing a respective image region of the currently processed image a second time, a temporal candidate vector, which is contained in a set of candidate motion vectors for a first pixel block (214, 314) of the currently processed image region (200.2, 300.3) and was ascertained for a third pixel block (216, 316) located outside the currently processed image region (200.2, 300.3) in the preceding image, by ascertaining a motion vector for the pixel block corresponding to the third pixel block (216, 316) in the currently processed image and replacing the temporal candidate vector with it.

15. The video-processing method of claim 14, wherein the step of ascertaining motion vectors for a plurality of first pixel blocks is performed proceeding from pixel block to pixel block within a currently processed image region according to a predetermined scan order, and wherein motion vectors for the pixel blocks of a current image region are ascertained at least twice using identical scan orders.

16. The video-processing method of claim 14, wherein the step of ascertaining motion vectors for a plurality of first pixel blocks is performed proceeding from pixel block to pixel block according to a predetermined scan order within a currently processed image region, and wherein motion vectors for the pixel blocks of a current image region are ascertained at least three times using at least two different scan orders.

17. The video-processing method of claim 14, comprising the steps of
processing an image (200) according to a fragmentation into a number of image regions (200.1 to 200.24; 300.1 to 300.24), each image region containing pixel blocks shared by a first number of pixel-block columns and a second number of pixel-block lines according to an adjustable aspect ratio, and
setting a different aspect-ratio value for processing a next image (300) of the image sequence, such that the number of image regions per image remains constant.

18. The video-processing method of claim 17, comprising the steps of
ascertaining a set of aspect ratio values, which leave the number of image regions per image constant, and of
selecting a different aspect-ratio value from this set for processing a next image.

19. The video-processing method of claim 18, wherein the number of image regions per image is selected such that the set of aspect ratio values contains at least a predetermined number of entries.

20. The video-processing method of claim 14, further comprising a step of fetching from an image memory into a high-level scratchpad (114) identically positioned sub-arrays (218, 218′; 318, 318′) of each the two consecutive images, each sub-array spanning at least the currently processed image region (200.2, 200.14; 300.3, 300.15).

21. The video-processing method of claim 14, wherein the step of ascertaining a motion vector for a respective first pixel block comprises evaluating pixel-block similarity between the respective first pixel block (C) and pixel blocks, which are selected from an image pair (200, 300) formed by consecutive images comprising the currently processed image and which are defined by the respective set of candidate motion vectors.

22. The video-processing method of claim 14, wherein ascertaining a motion vector for a respective first pixel block (C) comprises scanning a respective search area (204, 304, 305), which forms a predetermined sub-array of the image.

23. The video-processing method of claim 20, wherein a sub-array of the image that exceeds the currently processed image region by pixel blocks of a third number of pixel-block lines and a fourth number of pixel-block columns is loaded into the high-level scratchpad, such that the sub-array contains all respective search areas for first pixel-blocks, which are located at an edge of the current image region.

24. The video-processing method of claim 20, wherein a sub-array (218, 218′; 318, 318′) of the image exceeding a respective currently processed image region by pixel blocks of a fifth number of pixel-block lines and a sixth number of pixel-block columns is loaded into the high-level scratchpad, such that all respective search areas are loaded, which are needed for updating temporal vector candidates provided by third pixel blocks.

25. The video-processing method of further comprising a step of loading into a low-level scratchpad (116), which is arranged between the processing unit (104) and the high-level scratchpad (114), an identically positioned respective search area (204, 304) of each of the two consecutive images.

26. A data medium comprising a code for controlling the operation of a programmable processor in performing a video-processing method comprising the steps of
ascertaining motion vectors for a plurality of first pixel blocks, which form a currently processed image region of a currently processed image of an image sequence, proceeding from image region to image region and processing a respective image region at least twice before proceeding to a next image region,
ascertaining a motion vector for a currently processed first pixel block of the image region by evaluating a respective set of candidate motion vectors containing at least one temporal candidate vector, which is a motion vector that was ascertained for a second pixel block of a preceding image of the image sequence, and
updating, before processing a respective image region of the currently processed image a second time, a temporal candidate vector, which is contained in a set of candidate motion vectors for a first pixel block of the currently processed image region and was ascertained for a third pixel block located outside the currently processed image region in the preceding image, by ascertaining a motion vector for the pixel block corresponding to the third pixel block in the currently processed image and replacing the temporal candidate vector with it.

27. The data medium comprising a code for controlling the steps of
ascertaining motion vectors for a plurality, of first pixel blocks, which form a currently processed image region of a currently processed image of an image sequence, proceeding from image region to image region and processing image a respective image region at least twice before proceeding to a next image region,
ascertaining a motion vector for a currently processed first pixel block of the image region by evaluating a respective set of candidate motion vectors containing at least one temporal candidate vector, which is a motion vector that was ascertained for a second pixel block of a preceding image of the image sequence, and
updating, before processing a respective image region of the currently processed image a second time, a temporal candidate vector, which is contained in a set of candidate motion pixel block located outside the currently processed image region the preceding image, by ascertaining a motion vector for the pixel block corresponding to the third pixel block in the currently processed image and replacing the temporal candidate vector with it, wherein the code is adapted to control the operation of a programmable processor for performing a video-processing method of claim 15.
